(19) United States
(12) Patent Application Publication
(10) Pub. No.: US 2009/0283055 A1
(43) Pub. Date: Nov. 19, 2009

(54) FASTENERS AND RECEIVING UNITS FOR ANIMAL RESTRAINT SYSTEM

(76) Inventor: Lawrence L. Laske, Libertyville, IL (US)

Correspondence Address: Intellectual Property Dept.;Dewitt Ross & Stevens SC, 2 East Mifflin Street, Suite 600, Madison, WI, 53703-2865, US

(21) Appl. No.: 12/271,312

(22) Filed: Nov. 14, 2008

Related U.S. Application Data
(60) Provisional application No. 61/003,220, filed on Nov. 15, 2007.

(51) Int. Cl. A01K 27/00

(52) U.S. Cl. 119/796; 119/795

(57) ABSTRACT

Embodiments of the present invention provide a fastener and receiving unit and a leash having a fastener and receiving unit thereon such that a leash can be quickly and easily attached to a stationary object for securing an animal without removing the leash from the animal. Some embodiments include sliding fasteners or other fastener-receiving unit combinations that allow for attaching the leash to a variety of objects with different sizes and shapes. Other embodiments include elastic connectors disposed between two ends of a leash to provide stress relief from changes in tension on the leash when walking an animal or when the animal is securely attached to a stationary object. Further embodiments include using the fastener and receiving unit for adding an easily removable charm and/or charm bracelet.

### CROSS-REFERENCE TO RELATED APPLICATIONS

Priority is hereby claimed to U.S. provisional application Ser. No. 61/003,220, filed 15 Nov. 2007, which is incorporated herein.

### FIELD OF THE INVENTION

The present invention generally relates to animal restraints and, more particularly, to fasteners for attaching to an animal leash for quickly securing and releasing an animal via the animal leash to a stationary object.

### BACKGROUND

Many people have pets such as dogs and cats for companionship. These pets come in all shapes and sizes ranging from extremely large dogs to much smaller animals such as cats and the like. All of these pets generally require outdoor activity which may be in the form of a walk at the end of a leash. For example, many people will walk their dog to local retail establishments and then secure the animal outside of the store on a stationary object, such as a pole, while they are inside quickly browsing or shopping. Additionally, people may simply wish to quickly secure their animal to a stationary object while tying a shoe or performing such other menial tasks.

Currently, most individuals, to quickly secure their animals to a stationary object, remove the leash from a collar on their animal by using a clip provided on a first end of the leash from a ring provided on the collar. The individual then loops the leash around the stationary object and runs the leash through a loop provided on a second end of the leash to secure the leash to the stationary object. The individual then again secures the animal by fastening the clip provided on the first end of the leash to the ring provided on the collar worn by the animal.

Such a method of securing an animal to a stationary object exposes the animal and its caretaker or owner to dangerous situations. For example, when the leash is unfastened from the animal's collar, the animal can run away and possibly be lost or injured. Similarly, a caretaker/owner of the animal can be injured while attempting to re-secure or capture the animal. As such, what is needed is a means of quickly and easily securing an animal's leash to a stationary object without having to unfasten the leash from the animal's collar.

### SUMMARY OF THE INVENTION

Embodiments of the present invention address the deficiencies of the prior art by providing a fastener for attachment to a leash such that a leash can be quickly and easily attached to an object for securing an animal.

The various embodiments of the present invention include a leash having a fastener and a respective receiving clip near the far end of the leash for quickly and easily securing the leash and an animal secured by the leash to a stationary object. The use of “stationary object” throughout the description of the invention is intended to mean any object capable of preventing an animal secured by a leash to the object from straying without difficulty. As such, in accordance with the present invention, a stationary object can mean, a table, chair, bench and the like, capable of securing an animal. Stationary objects also include objects that, even though an animal may be able to drag, will impede the animal from a free and easy escape.

The invention provides an animal restraint comprising: a leash comprised of two ends, wherein a first end of the leash is configured to attach to an animal or an animal collar and a second end is configured to be held by a person; a fastener attached to the leash in a position proximate to the second end of the leash; a receiving unit attached to the leash in a position proximate to the second end of the leash, wherein the fastener is configured to reversibly connect to the receiving unit; and a leash portion between the fastener and the receiving unit, wherein wrapping the leash portion around a stationary object and attaching the fastener to the receiving unit secures the leash to the stationary object.

Further embodiments provide attachment plates and attachment fasteners for attaching the fasteners and receiving units to a leash. Other embodiments provide integrated fasteners and integrated receiving units that attach to a leash as single units. Other embodiments provide sliding fasteners that may move along the length of the leash to permit attaching the leash to a variety of objects having different diameters. In addition, stops may be added with the sliding fasteners to limit the movement of the sliding fastener along the length of the leash.

The invention also provides an animal restraint including a leash comprised of two ends, wherein a first end of the leash is configured to attach to a collar of an animal and a second end is configured to be held by a person, and an elastic connector disposed between the first and second ends of the leash. The elastic connector provides stress relief for both an animal connected to the leash as well as a person holding the leash, particularly with animals that have a tendency to pull against the leash with sudden starts. The elastic connector is especially important for relief of stress on an animal when the animal is secured to a stationary object because, unlike a person's hand or arm, the stationary object with not absorb or dampen the animal's sudden starts.

Additional embodiments further include an outer sleeve surrounding the elastic connector, wherein the outer sleeve prevents stretching of the elastic connector beyond a length of the outer sleeve.

The invention also provides for an animal restraint comprising a retractable leash assembly configured to be held by a person; a cord that retractably extends from the retractable leash assembly, wherein an end of the cord is configured to attach to an animal or an animal collar; and a fastener attached to the retractable leash assembly, the fastener configured to reversibly attach to the cord, wherein wrapping the retractable leash assembly around a stationary object and attaching the fastener to the cord secures the animal to the stationary object. The animal is thereby secured quickly without having to detach the leash from the dog collar.

### BRIEF DESCRIPTION OF THE DRAWINGS

The teachings of the present invention can be readily understood by considering the following detailed description in conjunction with the accompanying drawings. A brief description of the drawings is as follows.

FIG. 1A depicts a high level diagram of a fastener for attachment to a leash in accordance with an embodiment of the present invention.

FIG. 1B depicts a high level diagram of a receiving clip for attachment to a leash in accordance with an embodiment of the present invention.

FIG. 2 depicts a high level diagram of the fastener and receiving clip of FIGS. 1A and 1B attached to a leash, wherein the leash is attached to a pole using the fastening clip and receiving clip in accordance with an embodiment of the present invention.

FIG. 3A depicts a high level diagram of an animal attached to a parking meter using a leash comprising a fastener and receiving clip in accordance with an embodiment of the present invention.

FIG. 3B depicts a high level diagram of an animal attached to a bike rack using a leash comprising a fastener and receiving clip in accordance with an embodiment of the present invention.

FIG. 4A depicts a high level diagram of an alternate embodiment of a fastener in accordance with the present invention, wherein the fastener comprises a single piece and a leash is passed through the fastener.

FIG. 4B depicts a high level diagram of another alternate embodiment of a fastener in accordance with the present invention, wherein the fastener comprises a single piece and a leash is passed through the fastener.

FIG. 4C depicts a high level diagram of the embodiment of a fastener as shown in FIG. 4B but with no leash passed through the fastener.

FIG. 4D depicts a high level diagram of an alternate embodiment of a receiving unit in accordance with the present invention.

FIG. 5 depicts an alternate use for the fastener and receiving clip of the present invention for securing ornamental pieces.

FIG. 6 depicts an alternate use for the fastener and receiving clip of the present invention for securing a charm bracelet.

FIG. 7A depicts an embodiment of a fastener fitted on an existing retractable leash in accordance with an embodiment of the present invention.

FIG. 7B depicts an alternate use for a fastener fitted on an existing retractable leash in accordance with an embodiment of the present invention.

FIG. 8A depicts a side view of a leash with a sliding fastener.

FIG. 8B depicts a bottom view of a leash with a sliding fastener.

FIG. 9A depicts a side view of a leash with a sliding fastener and a receiving unit, wherein the fastener is clipped to the receiving unit.

FIG. 9B depicts a bottom view of a leash with a sliding fastener and a receiving unit, wherein the fastener is clipped to the receiving unit.

FIG. 10A depicts a leash with a sliding fastener and a receiving unit, wherein the fastener is not clipped to the receiving unit.

FIG. 10B depicts a leash with a sliding fastener and a receiving unit, wherein the fastener is clipped to the receiving unit.

FIG. 11A depicts a leash with an elastic connector, wherein the elastic connector is stretched to a maximum length determined by the length of the outer sleeve.

FIG. 11B depicts a leash with an elastic connector, wherein the elastic connector is unstretched in a relaxed state.

FIG. 12 depicts a leash containing a sliding fastener, a receiving unit, a stop disposed between the sliding fastener and the receiving unit that enables formation of a terminal loop, a collar clip, and, and elastic connector.

It should be understood that the drawings are for purposes of illustrating the concepts of the invention and are not necessarily the only possible configuration for the invention. To facilitate understanding, identical reference numerals have been used, where possible, to designate identical elements that are common to the figures.

### DETAILED DESCRIPTION OF THE INVENTION

The present invention advantageously provides a fastener and receiving unit and a leash having a fastener and receiving unit thereon such that a leash can be quickly and easily attached to a stationary object for securing an animal. The present invention also provides an elastic connector and a leash having an elastic connector thereon for relief of stress for a person and an animal caused by tension in the leash. Although the present invention will be described primarily within the context of a specific fastening clip, receiving unit, and/or elastic connector for a leash for securing a dog to a stationary object, the specific embodiments of the present invention should not be treated as limiting the scope of the invention. It will be appreciated by those skilled in the art and informed by the teachings of the present invention that the concepts of the present invention can be advantageously applied with substantially any equivalent fastener and receiving unit for securing substantially any animal to a stationary object.

It should be noted that the use of “stationary object” throughout the description of the invention is not intended to be limited to an object incapable of being moved but to mean any object capable of preventing an animal secured by a restraint to the object from straying without difficulty. As such, in accordance with the present invention, a stationary object can mean a table, chair, bench and the like.

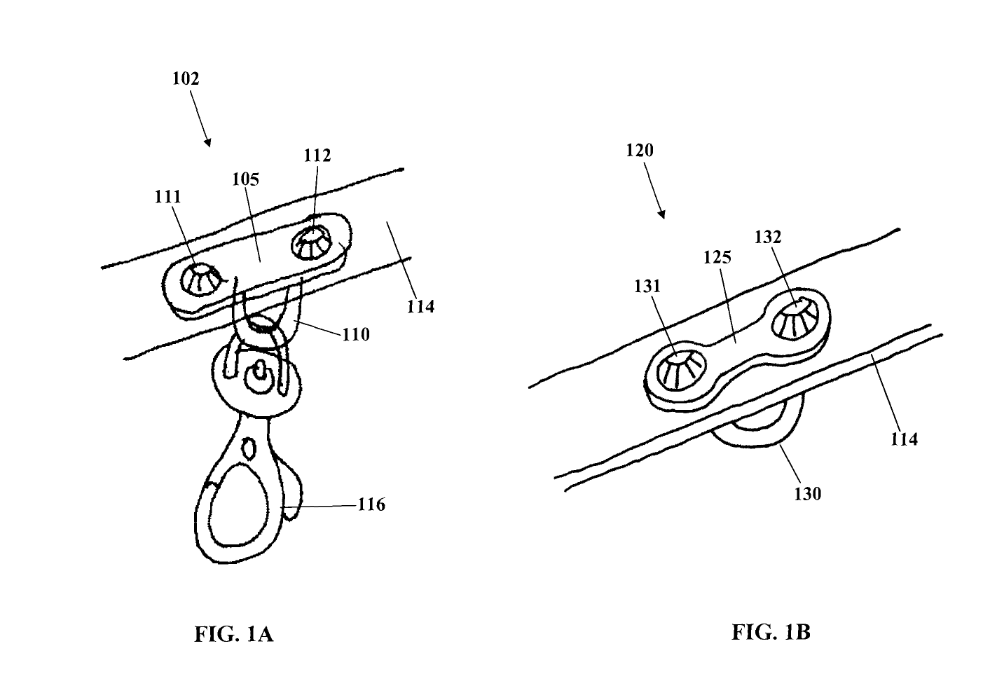

FIGS. 1A and 1B depict high level diagrams of a fastener and respective receiving unit for attachment to a leash in accordance with an embodiment of the present invention. The embodiment of FIG. 1A comprises a fastener 102 including an attachment plate 105 having a closed loop 110. The attachment plate 105 can further include two holes (not shown) for use with two attachment fasteners 111 and 112 (e.g., screws and nuts, rivets and the like) for securing the attachment plate 105 to a dog leash 114 (or any other type of animal restraint). The fastener 102 can further include a fastening clip 116 illustratively attached to the closed loop 110 of the attachment plate 105.

The embodiment of FIG. 1B comprises a receiving unit 120. The receiving unit 120 of FIG. 1 illustratively includes an attachment plate 125 having a closed loop 130. The attachment plate 125 can further include two holes (not shown) for use with two attachment fasteners 131 and 132 (e.g., screws and nuts, rivets and the like) for securing the attachment plate 125 to the dog leash 114.

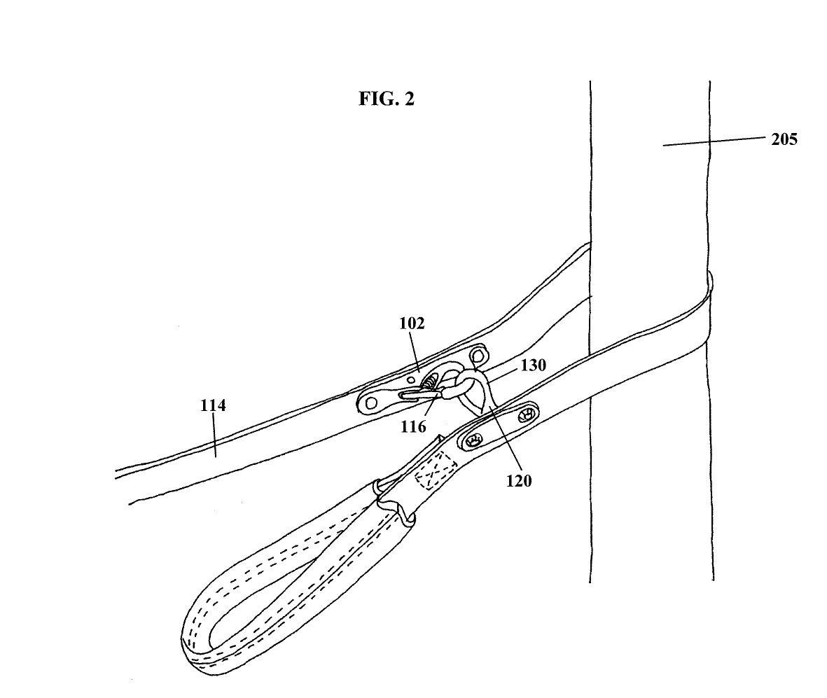

FIG. 2 depicts a high level diagram of the fastening clip 116 and receiving unit 120 of FIGS. 1A and 1B attached to a leash 114, wherein the leash 114 is attached to a pole 205 using the fastening clip 116 and receiving unit 120 in accordance with an embodiment of the present invention. In FIG. 2, the dog leash 114 is wrapped around a pole 205 and the fastening clip 116 of the fastener 102 is attached to the closed loop 130 of the receiving unit 120 for quickly and easily securing the dog leash 114 to the pole 205. In the embodiment of FIG. 2 the fastener 102 is depicted on the dog leash 114 closer to an end of the dog leash 114 that is intended to be attached to a dog. In alternate embodiments of the present invention, the fastener 102 can be attached on a leash at a position closer to the end of the dog leash intended to be held by someone using the leash to control the animal. Conversely, the receiving unit 120 can be located close to the end of the dog leash 114 that is intended to be attached to the dog.

The fastener 102 and/or receiving unit 120 can be placed at any point along the leash 114. Positioning the fastener 102 and/or receiving unit 120 closer to the end of the leash 114 intended to be attached to a dog provides a shorter lead (effective length of the leash 114) when attached to a stationary object or when walking a dog. In addition, the fastener 102 and/or receiving unit 120 may be placed along the leash 114 with any amount of distance between them. Shorter distances will allow for a tighter fit of the leash around an object when secured to the object. Longer distances will enable securing to a wider range of objects, particularly those with wider diameters.

Although FIG. 2 depicts a leash 114 with only one fastener 102 and one receiving unit 130, the leash may contain more than one fastener 102 and/or receiving unit 120 at different positions along the leash 114 to accommodate poles 205 or stationary objects of different diameters.

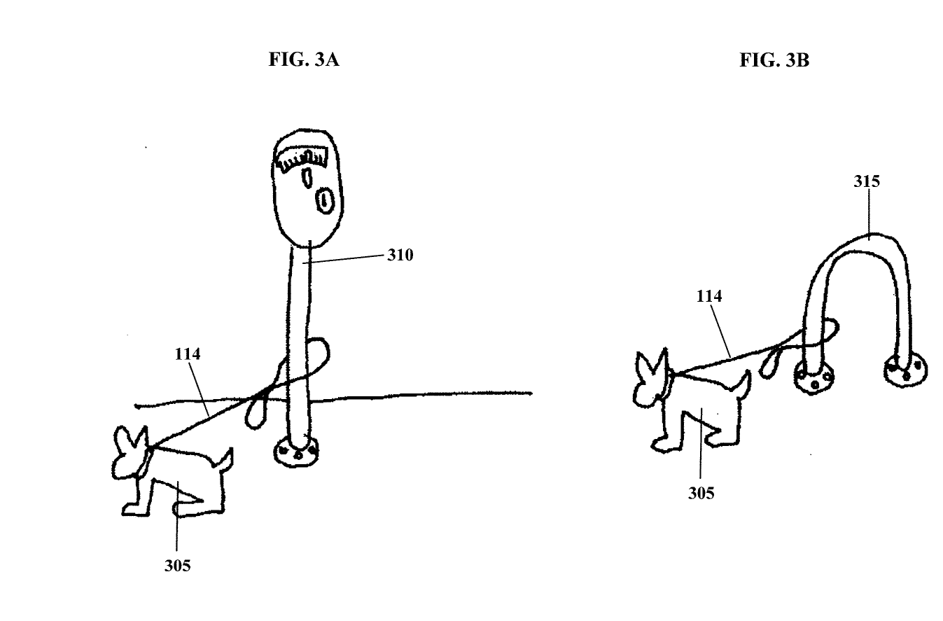

FIGS. 3A and 3B depict diagrams of an animal attached to a parking meter 310 (FIG. 3A) and a bike rack 315 (FIG. 3B) using a leash 114 comprising a fastening clip and receiving unit in accordance with an embodiment of the present invention. As depicted in FIGS. 3A and 3B the fastener and receiving unit of the present invention can be used to attach a dog 305 to a parking meter 310, a bike rack 315, or any other stationary object.

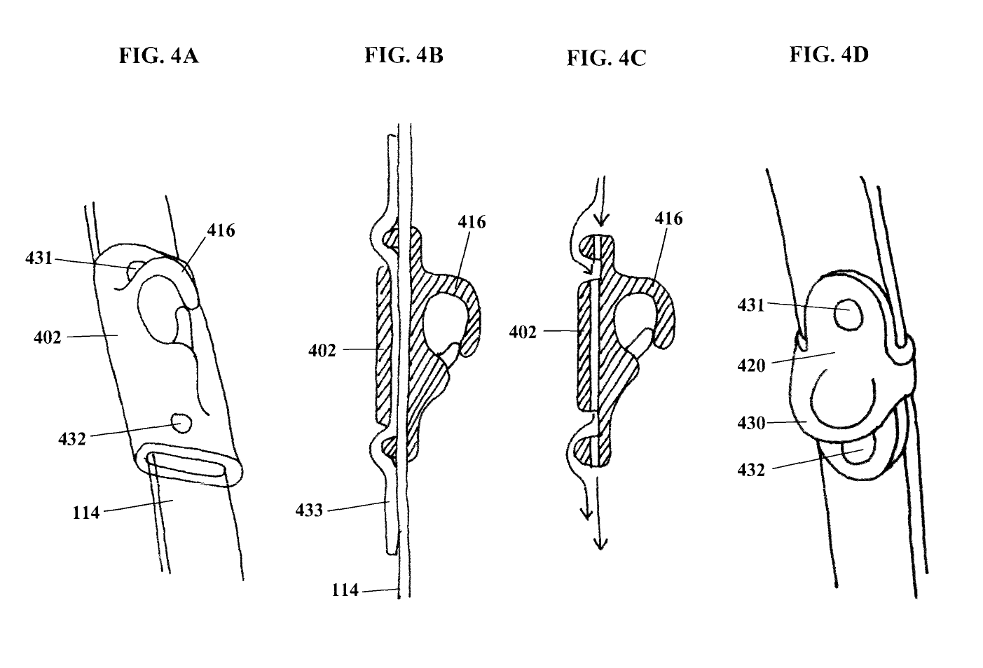

FIGS. 4A, 4B, 4C, and 4D depict diagrams of alternate embodiments of fasteners and a receiving unit in accordance with the present invention. The embodiments of FIGS. 4A, 4B, and 4C comprise fasteners 402 comprised of a single piece. That is, the fasteners 402 of FIG. 4A, 4B, and 4C comprise single units having a hollowed out centers and integrated fastening clips 416. The hollowed out centers of the fasteners 402 are used for passing leashes 114 through the fasteners 402 for securing the fasteners to the leashes 114. The fastener 402 of the embodiment depicted in FIG. 4A includes two holes (not shown) for use with two attachment fasteners 431 and 432 (e.g., screws and nuts, rivets and the like) for further securing the fastener to the dog leash 114. Alternatively, the fastener of the embodiment depicted in FIGS. 4B and 4C may be attached to the leash by an attachment strip 433 comprised of the same or different material as the dog leash 114, as shown in FIG. 4C. The attachment strip 433 may be attached to the dog leash 114 with attachment fasteners (not shown) (e.g., screws and nuts, rivets and the like) or by stitching.

The embodiment of FIG. 4D depicts an integrated receiving unit 420 comprised of a single piece. That is, the receiving unit 420 of FIG. 4 comprises a single unit having a hollowed out center and an integrated closed loop 430. The hollowed out center of the receiving unit 420 is used for passing the leash 114 through the receiving unit 420 for securing the receiving unit to the leash 114. The receiving unit 420 can further include two holes (not shown) for use with two attachment fasteners 431 and 432 (e.g., screws and nuts, rivets and the like) for further securing the fastener to the dog leash 114. The receiving unit can also be attached to the leash 114 by means of an attachment strip.

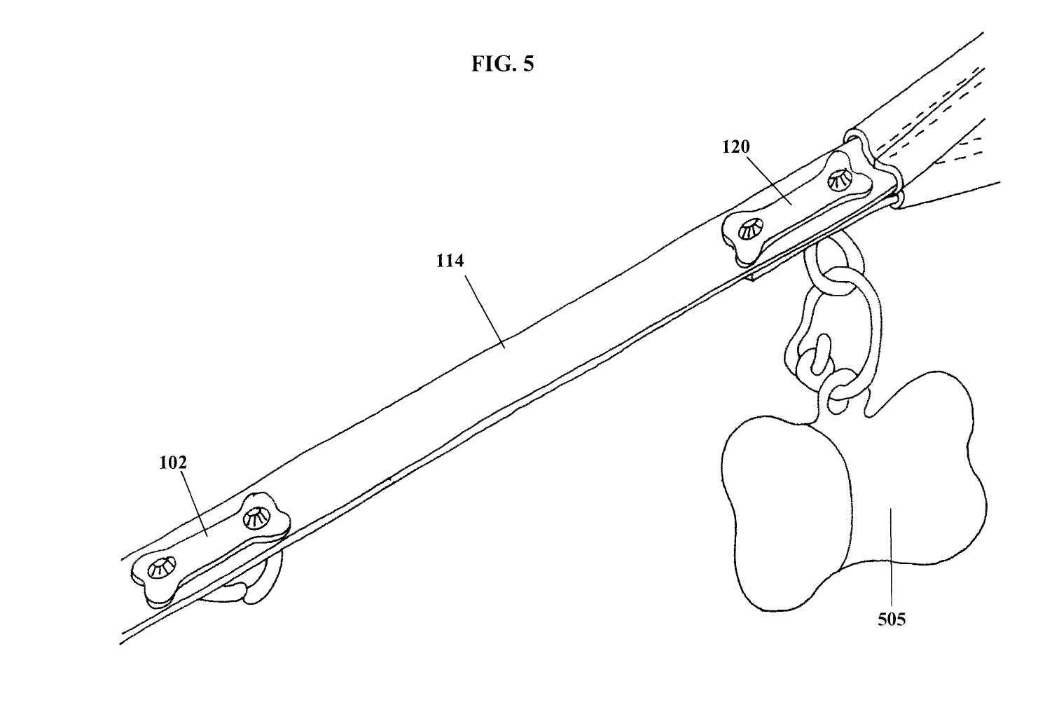

FIG. 5 depicts an alternate use for the fastener and receiving unit of the present invention for securing ornamental pieces. As depicted in FIG. 5, the fastener 102 and the receiving unit 120 of the present invention can be used to hang ornamental pieces 505 from the leash 114. That is, ornamental pieces 505 such as charms or other decorative pieces can be secured to the leash using the fastener 102 and the receiving unit 120 of the present invention. Even further, although in FIG. 5 the fastener 102 and receiving unit 120 of the present invention are depicted for securing ornamental pieces, in alternate embodiments of the present invention, the fastener and receiving unit of the present invention can be used for securing other accessories, such as dog waste bags and the like, to the leash 114.

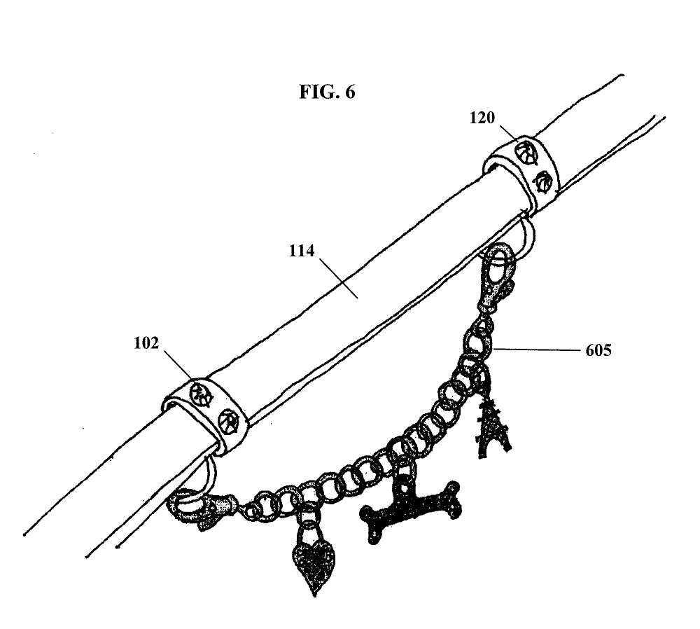

FIG. 6 depicts an alternate use for the fastener 102 and receiving unit 120 of the present invention, which includes securing a charm bracelet. For example, as depicted in FIG. 6, a charm bracelet 605 can be attached to the leash 114 via the fastener 102 and the receiving unit 120 of the present invention. The charm bracelet 605 can be easily attached and removed from the leash 114 such that another charm can be added and so that the charm bracelet 605 is not stolen. Additionally, the owner of the dog (e.g., a young girl) can easily take the charm bracelet 605 off the leash 114 and attach the charm bracelet 605 to her wrist when she is traveling on vacation so that she never feels away from her beloved dog. When she returns, she can place the charm bracelet 605 back on the leash 114 with an added charm from her vacation. If the leash 114 contains more than one fastener 102 and/or receiving unit 120, the charm may be attached to two fasteners 102, two receiving clips 120, or different combinations thereof.

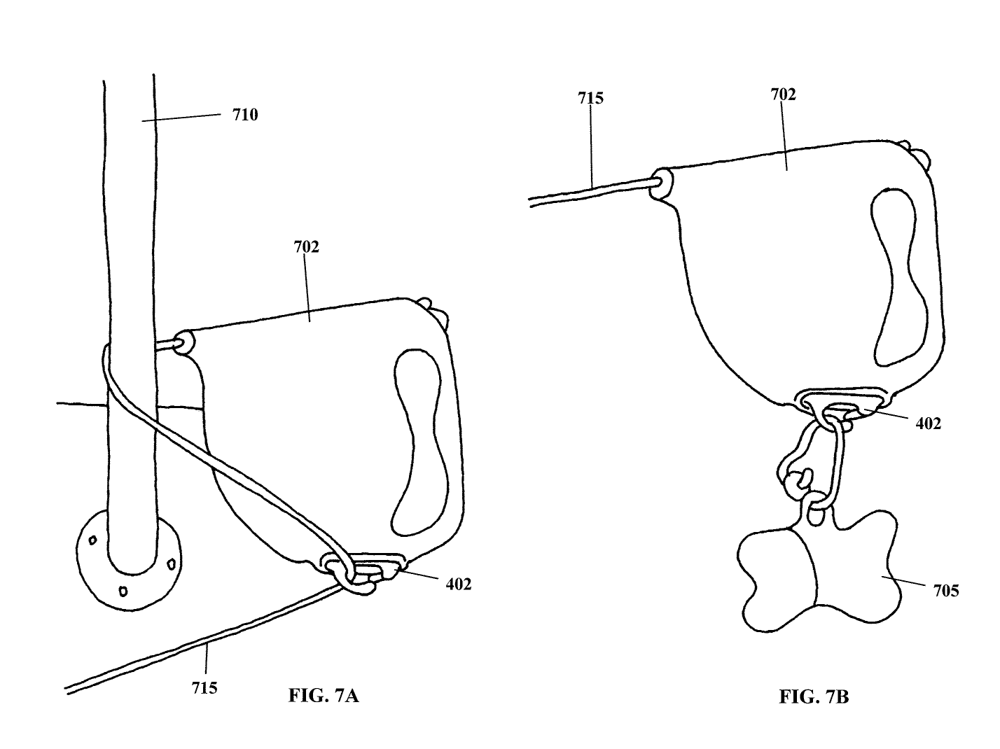

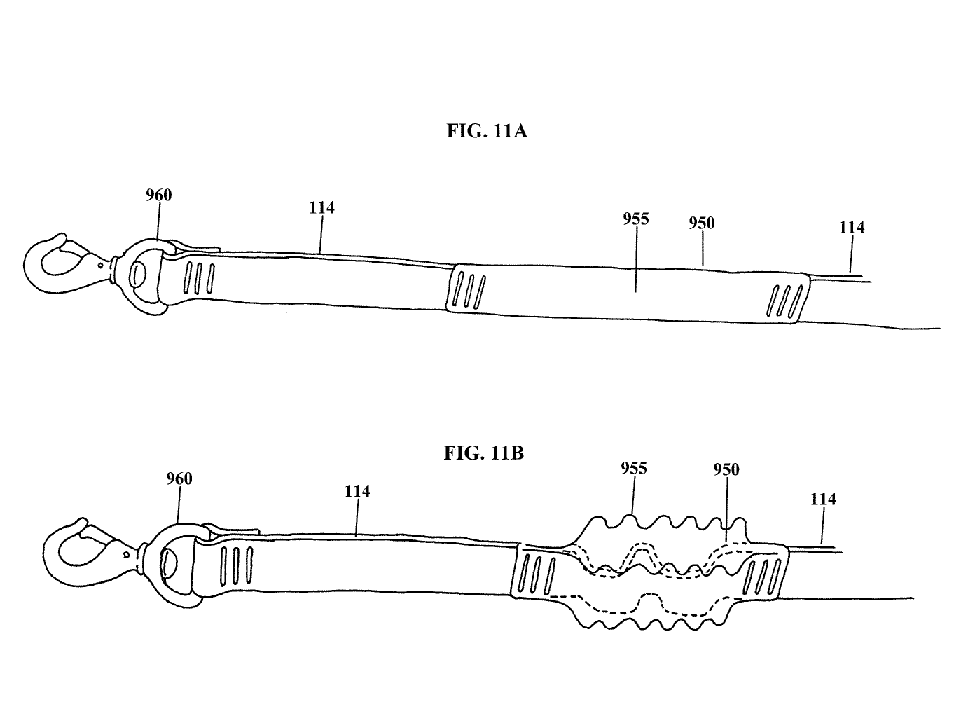

FIGS. 7A and 7B depict an embodiment of a fastener for use with a retractable leash in accordance with an embodiment of the present invention. As depicted in FIG. 7A, a retractable leash assembly 702 can be fitted with a fastener 402 in accordance with an embodiment of the present invention for providing a quick and easy means for attaching and detaching the leash from a stationary object. The fastener 402 can be placed anywhere on the body of the retractable leash assembly 702. In FIG. 7A, the retractable leash assembly 702 is wrapped around a stationary object 710 (e.g., a pole) and then the fastener 402 clips onto the retractable cord 715. This configuration provides for not having to detach a collar clip (960, as shown in FIG. 11A), from a dog collar, pass the collar clip 960 through the retractable leash assembly 702 handle, and reattach the collar clip 960 to the collar to secure the animal, and reverse the entire process to detach the cord 715 from the stationary object 710. In addition and as depicted in FIG. 7B, the fastener 402 of the present invention attached to the retractable leash assembly 702 can be used to hang ornamental pieces 705 or accessories from the leash assembly 702 as described above.

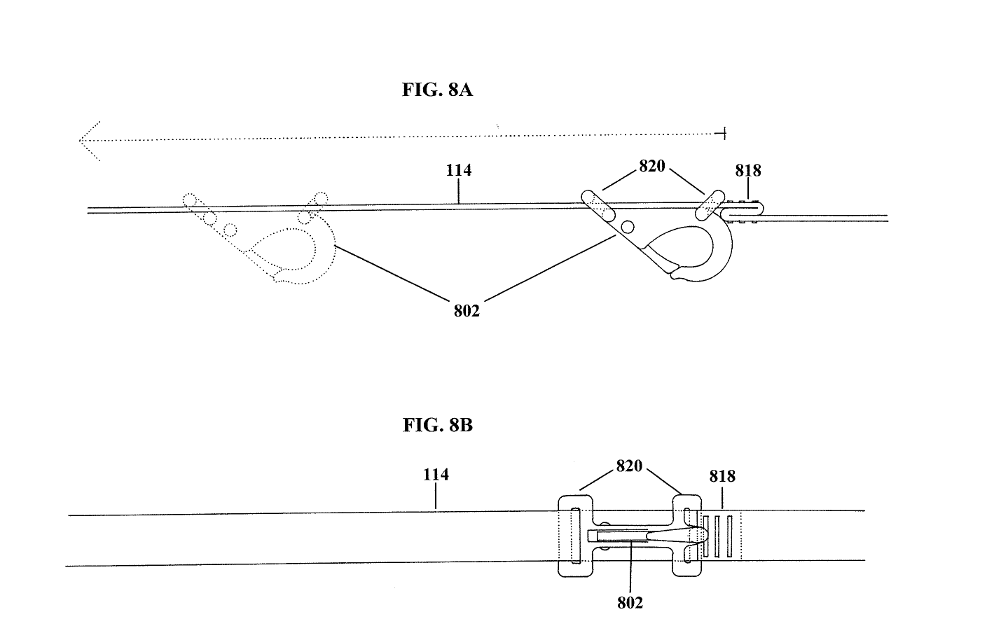

FIGS. 8A and 8B depict a side view and a bottom view, respectively, of an alternate embodiment of a sliding fastener 802 in accordance with the present invention, wherein the fastener 802 is slidingly engaged to a leash 114. As depicted in FIGS. 8A and 8B, the sliding fastener 802 is engaged to the leash 114 via integrated sliding attachment loops 820 through which the leash 114 is threaded. The range of movement of the fastener 802 along the length of the leash 114 can be limited by stops 818. In the embodiment depicted in FIGS. 8A and 8B, the stop 818 is comprised of the leash 114 itself, which is folded over and stitched to maintain the fold. The fold may alternatively be maintained by screws and nuts, rivets and the like. It is also contemplated that screws and nuts, rivets and the like, configured to extend beyond the depth of the leash 114 when inserted in unfolded portions of the leash 114, may also comprise stops 818.

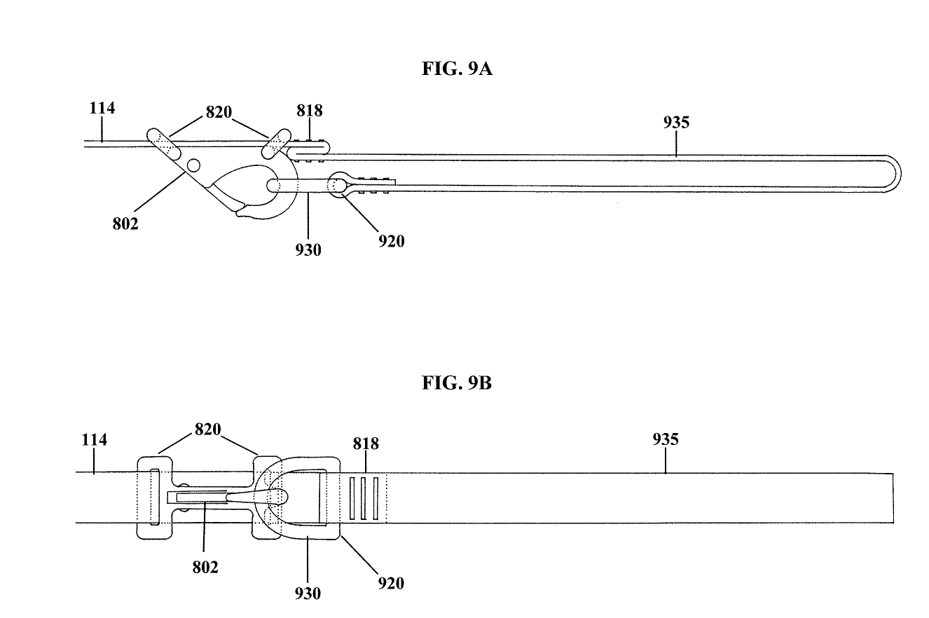

FIGS. 9A and 9B depict a side view and a bottom view, respectively, of the sliding fastener 802 depicted in FIGS. 8A and 8B but wherein a receiving unit 920 on the leash 114 is clipped to the sliding fastener 802. The receiving unit 920 is comprised of a “D ring” closed loop 930. The closed loop 930 is connected to the leash 114 whereby an end of the leash 114 is threaded through the closed loop 930, folded back, and attached to a more internal portion of the leash 114. The end of the leash 114 may be attached to the more internal portion of the leash 114 by stitching, screws and nuts, rivets and the like.

Clipping the closed loop 930 of the receiving unit 920 to the sliding fastener 802 as depicted in FIGS. 9A and 9B forms a terminal loop 935 with which a person may securely grip the leash 114. A stop 818 disposed between the receiving unit 920 and the sliding fastener 802 prevents reducing the size of the terminal loop 935 beyond a minimal diameter. Sliding the sliding fastener 802 along the leash 114 in a direction opposite the receiving unit 920 allows for increasing the size of the terminal loop to a range of diameters. This provides an ability to secure the dog (or animal) via the leash 114 to a variety of objects (e.g., parking meter, fire hydrant, trees) having different diameters.

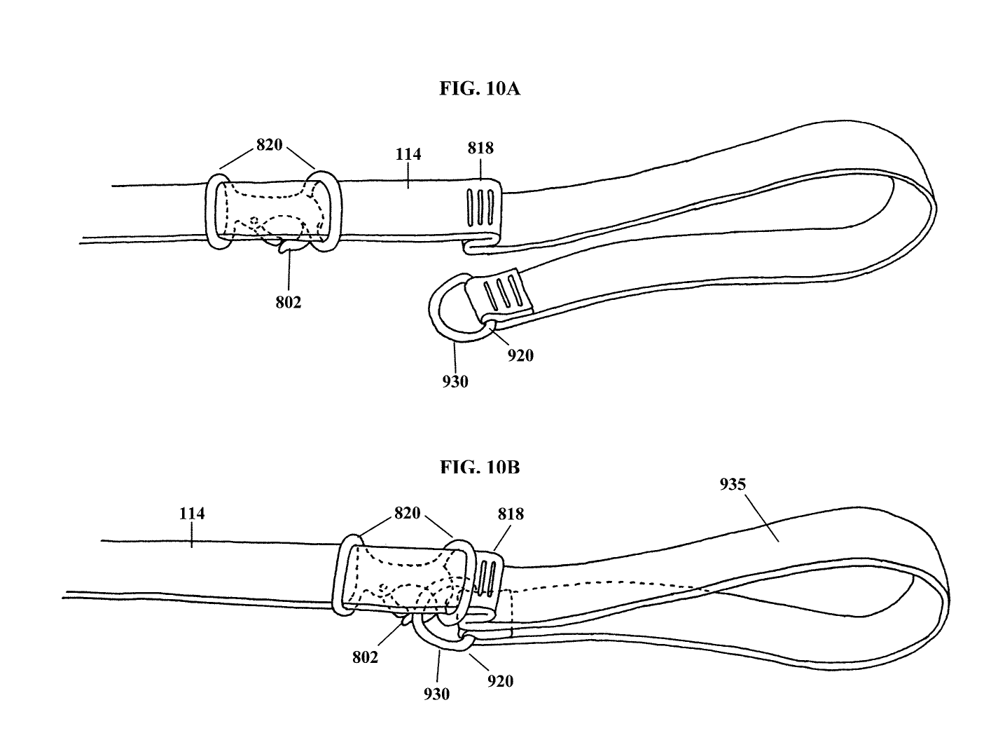

FIGS. 10A and 10B show other views of a leash 114 with a sliding fastener 802 connected to the leash 114 with integrated sliding attachment loops 820, a stop 818, and a receiving unit 920 with a closed loop 930. The receiving unit 920 can be unclipped to the sliding fastener 802, as depicted in FIG. 10A, or clipped to the sliding faster 802 thereby forming a terminal loop 935, as depicted in FIG. 10B.

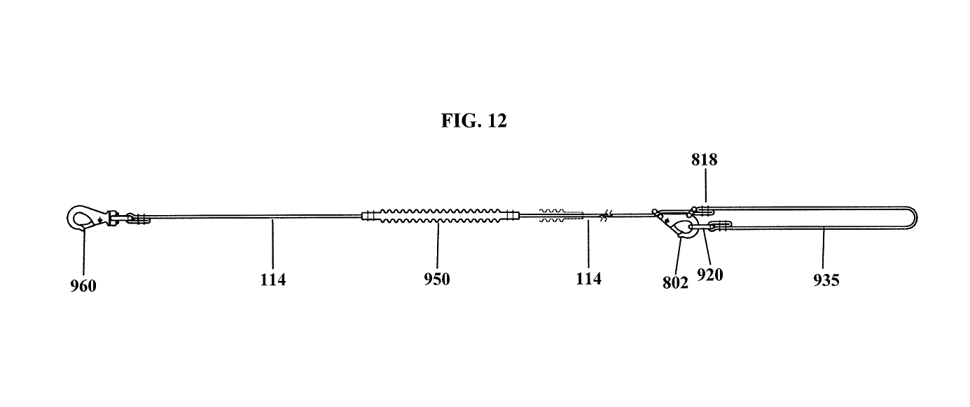

FIGS. 11A and 11B show various depictions of a leash 114 with an elastic connector 950. The elastic connector 950 is disposed between two portions of the leash 114, wherein one portion includes a collar clip 960 or other means for attaching the leash 114 to a collar of an animal, and a second portion comprises a portion held by a person (not shown) such as a terminal loop 935 (as shown in FIG. 10B). The elastic connector 950 can be disposed anywhere along the length of the leash 114 but is preferably located just far enough away from the collar clip 960 so as not to rub against a dog attached thereto (see, e.g., FIG. 12). In embodiments wherein the leash 114 also contains a sliding fastener 802 and a receiving unit 920, a position of the elastic connector 950 proximal to the collar clip 960 allows for expansion of the terminal loop to the largest diameter possible, the stopping point being the elastic connector 950.

The elastic connector 950 provides stress relief for both an animal connected to the leash as well as a person holding the leash 114, particularly with animals that have a tendency to pull against the leash 114 with sudden starts. The elastic properties of the elastic connector 950 softens and dampens the rapid change in tension caused by the animal's sudden starts and relieves the stress on the person's hand, bones and spine as well as the animal's neck and spine, etc.

The elastic connector 950 can be made of any material with elastic properties that endow the connector with the ability to stretch in response to tension, as depicted in FIG. 11A, and retract, as depicted in FIG. 11B. Examples of such materials include but are not limited to natural rubber or synthetic polymer materials.

The elastic connecter 950 can be manufactured in several ways. In one variation, the leash is separated or cut to form a gap between both ends of the leash 114. Two pieces of elastic rubber, which comprise the elastic connector 950, are placed on either side of the leash 114 (one on top and one on the bottom) to form a “sandwich” and positioned to span the gap in the leash 114. The sandwiched portions of the elastic connector 950, consisting of the two ends of the elastic rubber and the leash 114, are then connected by any one of several means including stitching, screws and nuts, rivets and the like. An outer sleeve 955 of a non-elastic material may optionally be attached by the above-mentioned means over the elastic rubber with enough slack between the two attached ends to allow stretching of the rubber to occur. The memory quality of the elastic rubber allows the elastic connector 950 to pull inwards to collapse the gap between the two ends of the leash, as depicted in FIG. 11B. When tension is exerted on the leash 114, the elastic connector 950 stretches lengthwise, stopping when either the elastic rubber cannot stretch any further, as depicted in FIG. 11A, or when the elastic has stretched to the length of the outer sleeve 955. The elastic connectors 950 can be connected to any type or shape of leash, including round leashes or chain leashes. Appropriate methods and materials for connecting the elastic connectors to such leashes are well known in the art.

FIG. 12 depicts one of many embodiments of the invention, comprising a leash 114 containing a sliding fastener 802, a receiving unit 920, a stop 818 disposed between the sliding fastener 802 and the receiving unit 920 that enables formation of a terminal loop 935, a collar clip 960, and an elastic connector 950.

The operation of a leash with a sliding fastener 818 may occur as follows. A leash 114 containing a sliding fastener 802, a receiving unit 920, a stop 818 disposed between the sliding fastener 802 and the receiving unit 920 that enables formation of a terminal loop 935, a collar clip 960, and, optionally, an elastic connector 950, as shown in FIG. 12, is provided. With a dog attached via a collar to the collar clip 960, a person holds the leash 114 by the terminal loop 935 with a first hand. The stop 818 prevents the sliding fastener 802 from moving beyond a minimal diameter of the terminal loop 935 so that the terminal loop 935 does not collapse around the first hand. With a second hand, the person then grips a portion of the leash 114 between the sliding fastener 802 and the collar clip 960, preferably close to—if not against—the sliding fastener 802. The person then releases the first hand from the terminal loop 935 and unclips the sliding fastener 802 from the receiving unit 920. The person then holds a portion of the leash 114 between the sliding fastener 802 and the receiving unit 920 (preferably close to—if not against—the stop 818) with the first hand and, with the second hand, slides the sliding fastener 802 along the leash 114 towards the collar clip 960 to a distance greater than the diameter of the stationary object to which the leash is to be attached. With the second hand still gripping the sliding fastener 802 or any other portion of the leash 114 close to—if not against—the sliding fastener 802, the person wraps the receiving unit 920 around the stationary object with the first hand and clips the receiving unit 920 to the sliding fastener 802. The dog is thereby secured to the stationary object.

Depending on the angle or size of the integrated attachment loops 820 on the sliding fastener 802, the leash 114 may pass through the integrated attachment loops 820 freely or with resistance. If the attachment loops 820 are configured to permit the leash 114 to pass freely, any tension exerted on the leash 114 by the dog or the person allows the sliding fastener 802 to slide along the leash toward the stationary object, thereby minimizing the diameter of the terminal loop 935 and reducing any slack around the object. Alternatively, if the attachment loops 820 are configured to exert resistance while sliding the sliding fasteners 802 along the leash 114, the person may need to slide the sliding fastener 802 manually toward the stationary object to minimize the diameter of the terminal loop 935 and reduce slack.

Sliding the sliding fastener 802 along the leash 114 towards the collar clip maximizes the diameter of the terminal loop 935. The maximum diameter of the terminal loop 935 may vary depending on whether the leash 114 contains an elastic connector 950 or not. If the leash 114 contains an elastic connector 950, its position on the leash 114 defines the maximum diameter of the terminal loop 935, as the sliding fastener 802 cannot move beyond the elastic connector 950. If the leash 114 does not contain an elastic connector 950, the collar clip 960 defines the maximum diameter of the terminal loop 935.

In a version of the leash in which the attachment loops 820 are configured to exert resistance while sliding the sliding fasteners 802 along the leash 114, the sliding fastener 802 may be stably positioned at any point along the length of the leash 114. The position of the sliding fastener 802 determines the diameter of the terminal loop 935 and the effective leash 114 length in an inverse manner. Thus, positioning the sliding fastener 802 for larger-diameter terminal loops 935 leads to shorter effective leash 114 lengths. Conversely, positioning the sliding fastener 802 for smaller-diameter terminal loops 935 leads to longer effective leash 114 lengths. The ability to adjust the effective length of the leash 114 allows for a multitude of lengths between the animal and the person or between the animal and the stationary object.

It is contemplated that the fasteners, receiving units, and elastic connectors described herein may be applicable to any type of animal restraint, such as chains, cords, leashes etc. The fasteners, receiving units, and elastic connectors can be connected to the animal restraint in a manner appropriate to the configuration and composition of the restraint.

The embodiments of the invention described herein are compatible with any type of fasteners and cognate receiving units and are not limited to the types shown in the figures. A variety of fasteners and receiving units are well known in the art. Likewise, the embodiments of the invention described herein are also compatible with any type of closed loop contained within the receiving unit. For example, the closed loop may have curvature in up to three axes rather than only two, as is shown in the figures herein.

Alternative embodiments of the present invention also include fasteners and cognate receiving units in a “belt buckle” design. In this version, the receiving unit comprises multiple perforations in the leash at a variety of distances from the end of the leash held by the human. The fastener comprises a belt buckle-type fastening device disposed closer to the center of the leash. The leash can be fastened in the same manner as a belt, which serves to form a terminal loop in the end of the leash held by the person. The multitude of perforations allows for formation of terminal loops of several different diameters to permit adjustability to fasten the leash around objects of different diameters.

Yet another embodiment of the present invention includes a chain comprised of a collar clip attached to one end of the chain and a fastening clip attached to the other end. The fastener is configured to be able to clip to any of the many chain links disposed between the fastener itself and the collar clip to create end loops of different diameters.

Having described various embodiments of the current invention (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

What is claimed is:

1. An animal restraint system comprising:
a leash comprised of two ends, wherein a first end of the leash is configured to attach to an animal or an animal collar and a second end is configured to be held by a person;
a fastener attached to the leash;
a receiving unit attached to the leash, wherein the fastener is configured to reversibly connect to the receiving unit; and
a leash portion between the fastener and the receiving unit.

2. The animal restraint system of claim 1, wherein the fastener further comprises an attachment plate.

3. The animal restraint system of claim 2, wherein the fastener further comprises attachment fasteners.

4. The animal restraint system of claim 1, wherein the receiving unit further comprises a closed loop connected to an attachment plate.

5. The animal restraint system of claim 1, wherein the fastener is an integrated fastener comprising a single unit defining a hollowed out center and an integrated fastening clip.

6. The animal restraint system of claim 1, wherein the receiving unit is an integrated receiving unit comprising a single unit defining a hollowed out center and an integrated closed loop.

7. The animal restraint system of claim 1, wherein the fastener is a sliding fastener, wherein the sliding fastener is configured to define a terminal loop of variable diameter when connected to the receiving unit.

8. The animal restraint of claim 7, wherein the sliding fastener is configured to slide on the leash with resistance.

9. The animal restraint system of claim 7, further comprising integrated sliding attachment loops disposed on the sliding fastener.

10. The animal restraint system of claim 7, further comprising a stop dimensioned and configured to limit movement of the sliding fastener along the leash.

11. The animal restraint system of claim 10, wherein the stop is positioned on the leash to prevent reducing the diameter of the terminal loop beyond a minimal diameter.

12. The animal restraint system of claim 11, wherein the stop is selected from the group consisting of a fold, a screw and nut, and a rivet.

13. The animal restraint system of claim 1, further comprising an elastic connector disposed between the first and second ends of the leash.

14. The animal restraint system of claim 13, further comprising an outer sleeve surrounding the elastic connector, wherein the outer sleeve prevents stretching of the elastic connector beyond a length of the outer sleeve.

15. The animal restraint system of claim 1, wherein the fastener comprises a fastening clip and the receiving unit comprises a closed loop.

16. The animal restraint system of claim 1, further comprising a retractable leash assembly disposed at the second end of the leash.

17. An animal restraint system comprising:
a leash comprised of two ends, wherein a first end of the leash is configured to attach to a collar of an animal and a second end is configured to be held by a person; and
an elastic connector disposed between the first and second ends of the leash.

18. The animal restraint system of claim 17, further comprising an outer sleeve surrounding the elastic connector, wherein the outer sleeve prevents stretching of the elastic connector beyond a length of the outer sleeve.

19. The animal restraint system of claim 17, further comprising a fastener attached to the leash, a receiving unit attached to the leash, and a leash portion between the fastener and the receiving unit.

20. The animal restraint system of claim 19, further comprising a sliding fastener, wherein the sliding fastener is configured to define a terminal loop of variable diameter when connected to the receiving unit, and further comprising a stop dimensioned and configured to limit movement of the sliding fastener along the leash, wherein the stop is positioned on the leash to prevent reducing the diameter of the terminal loop beyond a minimal diameter.
